(19) United States
(12) Patent Application Publication
(10) Pub. No.: US 2024/0135606 A1
(43) Pub. Date: Apr. 25, 2024

(54) CAMERA MONITOR SYSTEM WITH ANGLED AWARENESS LINES

(71) Applicant: STONERIDGE ELECTRONICS AB, Solna (SE)

(72) Inventors: Utkarsh Sharma, Farmington Hills, MI (US); Liang Ma, Rochester, MI (US); Nguyen Phan, Allen Park, MI (US); Troy Cooprider, White Lake, MI (US)

(21) Appl. No.: 18/376,583

(22) Filed: Oct. 3, 2023

Related U.S. Application Data
(60) Provisional application No. 63/418,688, filed on Oct. 24, 2022.

(51) Int. Cl. G06T 11/20; B60K 35/00; G06V 20/56; H04N 7/18; H04N 23/90

(52) U.S. Cl. CPC G06T 11/203; B60K 35/00; G06V 20/588; H04N 7/181; H04N 23/90; B60K 2370/152; B60K 2370/16; B60K 2370/21

(57) ABSTRACT

A method of displaying awareness lines in a camera monitor system for a vehicle includes detecting an adjacent lane marker to the vehicle, calculating an awareness line that is perpendicular to the adjacent lane marker, and displaying the awareness line in relation to a trailer end location.

### CROSS-REFERENCE TO RELATED APPLICATION

This application claims priority to U.S. Provisional Application No. 63/418,688 filed Oct. 24, 2022.

### TECHNICAL FIELD

This disclosure relates to a camera monitor system (CMS) for use in a commercial truck or similar vehicle, and, in particular, to a CMS having displayed awareness lines relating to vehicle location.

### BACKGROUND

Mirror replacement systems, and camera systems for supplementing mirror views, are utilized in commercial vehicles to enhance the ability of a vehicle operator to see a surrounding environment. Camera monitor systems (CMS) utilize one or more cameras to provide an enhanced field of view to a vehicle operator. In some examples, the CMS covers a larger field of view than a conventional mirror, or include views that are not fully obtainable via a conventional mirror.

In a typical CMS, there is a camera arm arranged on each of the left- and right-hand sides of the vehicle to provide Class II and Class IV views. A display is provided on the A-pillar on both driver and passenger sides to display the field of view for the camera arm on that side, simulating a conventional mirror.

Long trailers frequently are pulled by tractors in commercial trucking. It is difficult for the driver to accurately observe the location of the trailer end during maneuvers such as lane changes. To this end, it is desirable to provide a CMS that displays “awareness lines” that are calculated to indicate the trailer end location or a location aft of the trailer end in order to allow the driver to operate the vehicle more safely.

### SUMMARY

In one exemplary embodiment, a method of displaying awareness lines in a camera monitor system for a vehicle includes detecting an adjacent lane marker to the vehicle, calculating an awareness line that is perpendicular to the adjacent lane marker, and displaying the awareness line in relation to a trailer end location.

In a further embodiment of any of the above, the adjacent lane marker is at least one of a dashed line lane marker or a solid line lane marker in the roadway.

In a further embodiment of any of the above, the adjacent line is immediately adjacent to a tractor trailer that is indicative of the trailer end location.

In a further embodiment of any of the above, the method includes a step of capturing images with a camera, and the detecting step is performed using a line recognition algorithm based upon the captured images.

In a further embodiment of any of the above, the method includes a step of mapping real world distance to pixel distance, and the displaying step includes displaying the pixel distance to illustrate the awareness line.

In a further embodiment of any of the above, the displaying step includes illustrating the awareness line at the trailer end location.

In a further embodiment of any of the above, the displaying step includes illustrating the awareness line aftward of the trailer end location to indicate a distance behind the trailer end location.

In a further embodiment of any of the above, the displaying step includes illustrating the awareness line as a width corresponding to one lane in the roadway.

In a further embodiment of any of the above, the adjacent lane marker is curved, and the awareness line is displayed perpendicular to a line tangent to the curved adjacent lane marker.

In another exemplary embodiment, a camera monitor system for a vehicle includes multiple cameras that include first and second cameras that respectively provide first and second fields of view. Multiple displays include first and second displays that are configured to respectively depict at least portions of the first and second fields of view. A controller is in communication with the first and second displays and the first and second cameras. The controller is configured to detect an adjacent lane marker to the vehicle based upon images that are captured by at least one of the first and second camera. The controller is configured to calculate an awareness line that is perpendicular to the adjacent lane marker and display the awareness line on at least one of the first and second displays in relation to a trailer end location of the vehicle.

In a further embodiment of any of the above, the first and second fields of view respectively capture left and right sides of a vehicle. Each of the first and second fields of view include at least a portion of Class II and/or Class IV views.

In a further embodiment of any of the above, the adjacent lane marker is at least one of a dashed line lane marker or a solid line lane marker in the roadway.

In a further embodiment of any of the above, the adjacent line is immediately adjacent to a tractor trailer that is indicative of the trailer end location.

In a further embodiment of any of the above, the controller is configured to perform a line recognition algorithm to identify the adjacent lane marker based upon the captured images.

In a further embodiment of any of the above, the controller is configured to map real world distance to pixel distance, and the awareness line illustrates the pixel distance.

In a further embodiment of any of the above, the controller is configured to illustrate the awareness line on the at least one of the first and second displays at the trailer end location.

In a further embodiment of any of the above, the controller is configured to illustrate the awareness line aftward of the trailer end location to indicate a distance behind the trailer end location.

In a further embodiment of any of the above, the controller is configured to illustrate the awareness line as a width corresponds to one lane in the roadway.

In a further embodiment of any of the above, the adjacent lane marker is curved, and the controller is configured to display the awareness line perpendicular to a line that is tangent to the curved adjacent lane marker.

### BRIEF DESCRIPTION OF THE DRAWINGS

The disclosure can be further understood by reference to the following detailed description when considered in connection with the accompanying drawings wherein:

FIG. 1A is a schematic front view of a commercial truck with a camera monitor system (CMS) used to provide at least Class II and Class IV views.

FIG. 1B is a schematic top view of a commercial truck with a camera mirror system providing Class II, Class IV, Class V and Class VI views.

FIG. 2 is a schematic top view of a vehicle cabin including displays.

FIG. 3 is a flowchart illustrating a method of generating an awareness line on at least one of the displays.

FIG. 4 is a depicting of awareness lines on the display according to the disclosed method.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible. Like reference numbers and designations in the various drawings indicate like elements.

### DETAILED DESCRIPTION

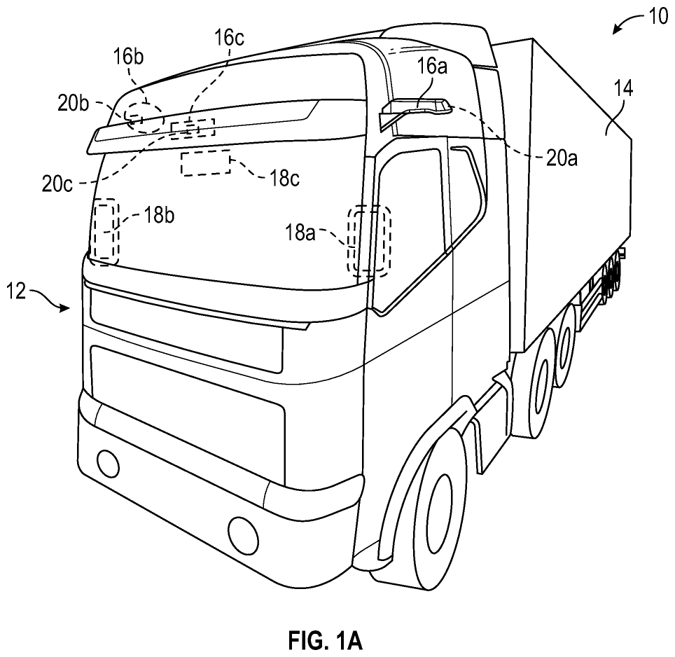

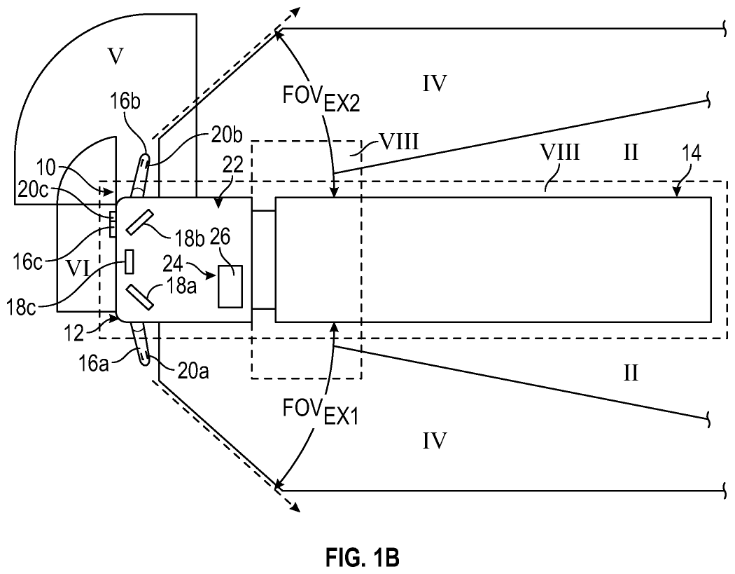

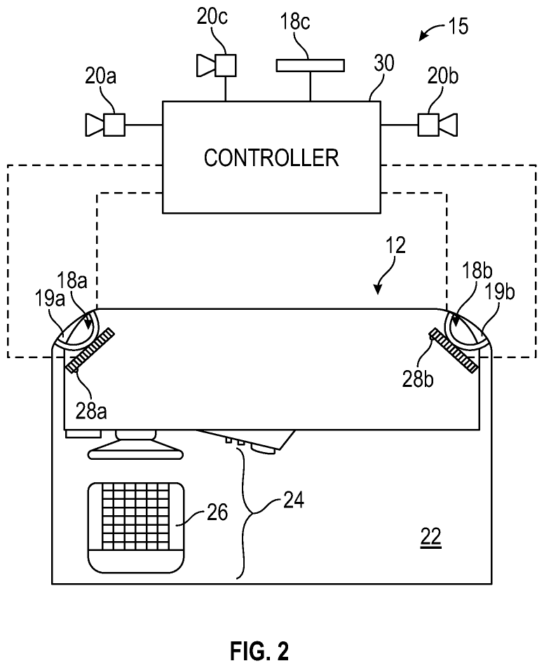

A schematic view of a commercial vehicle 10 is illustrated in FIGS. 1A and 1B. The vehicle 10 includes a vehicle cab or tractor 12 for pulling a trailer 14. It should be understood that the vehicle cab 12 and/or trailer 14 may be any configuration. Although a commercial truck is contemplated in this disclosure, the invention may also be applied to other types of vehicles. The vehicle 10 incorporates a camera monitor system (CMS) 15 (FIG. 2) that has driver and passenger side camera arms 16a, 16b mounted to the outside of the vehicle cab 12. If desired, the camera arms 16a, 16b may include conventional mirrors integrated with them as well, although the CMS 15 can be used in some examples to entirely replace mirrors. In additional examples, each side can include multiple camera arms, each arm housing one or more cameras and/or mirrors. Each arm 16a, 16b may also provide a housing that encloses electronics, e.g., a controller, that are configured to provide various features of the CMS 15.

Each of the camera arms 16a, 16b includes a base that is secured to, for example, the cab 12. A pivoting arm is supported by the base and may articulate relative thereto. At least one rearward facing camera 20a, 20b is arranged respectively within camera arms 16a, 16b. The exterior cameras 20a, 20b respectively provide an exterior field of view FOV_{EX1}, FOV_{EX2} that each include at least one of the Class II and Class IV views (FIG. 1B), which are legal prescribed views in the commercial trucking industry. The Class II view on a given side of the vehicle 10 is a subset of the class IV view of the same side of the vehicle 10. Multiple cameras also may be used in each camera arm 16a, 16b to provide these views, if desired. Class II and Class IV views are defined in European R46 legislation, for example, and the United States and other countries have similar driver visibility requirements for commercial trucks. Any reference to a “Class” view is not intended to be limiting, but is intended as exemplary for the type of view provided to a display by a particular camera.

First and second video displays or monitors 18a, 18b are arranged on each of the driver and passenger sides within the vehicle cab 12 on or near the A-pillars 19a, 19b (generally, A-pillar 19) to display Class II and Class IV views on its respective side of the vehicle 10, which provide rear facing side views along the vehicle 10 that are captured by the exterior cameras 20a, 20b.

If video of Class V and/or Class VI views are also desired, a camera housing 16c and camera 20c may be arranged at or near the front of the vehicle 10 to provide those views (FIG. 1B). A third display 18c arranged within the cab 12 near the top center of the windshield can be used to display the Class V and Class VI views, which are toward the front of the vehicle 10, to the driver. The displays 18a, 18b, 18c (generally, display 18) face a driver region 24 within the cabin 22 where an driver/operator is seated on a driver seat 26. The location, size and field(s) of view streamed to any particular display may vary from the configurations described in this disclosure and still incorporate the disclosed invention.

If video of Class VIII views is desired, camera housings can be disposed at the sides and rear of the vehicle 10 to provide fields of view including some or all of the Class VIII zones of the vehicle 10. In such examples, the third display 18c can include one or more frames displaying the Class VIII views. Alternatively, additional displays can be added near the first, second and third displays 18a, 18b, 18c and provide a display dedicated to providing a Class VIII view.

Referring to FIG. 2, each display 18a, 18b (and perhaps others, if desired) includes a housing mounted to its respective A-pillar 19 (i.e., 19a, 19b) by a bracket, for example, or integrated into vehicle trim. A screen 28 (i.e., 28a, 28b) is mounted in a front of the housing facing the driver. The screen 28 can be any suitable screen such as TFT, LCD, LED, OLED and others.

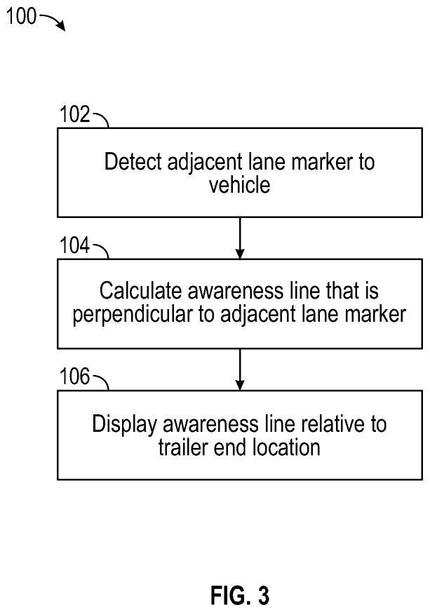

It is difficult for the driver to accurately observe the location of the trailer end during maneuvers such as lane changes due to the relatively long length of the trailer. To this end, it is desirable to provide “awareness lines” on at least one of the displays 18a, 18b that are calculated to indicate the trailer end location or a location aft of the trailer end in order to allow the driver to operate the vehicle more safely. A method 100 of creating and displaying awareness lines is shown in FIG. 3. Generally, the method includes the steps of detecting an adjacent lane marker to the vehicle (block 102), calculating an awareness line that is perpendicular to the adjacent lane marker (block 104), and displaying the awareness line in relation to a trailer end location (block 106).

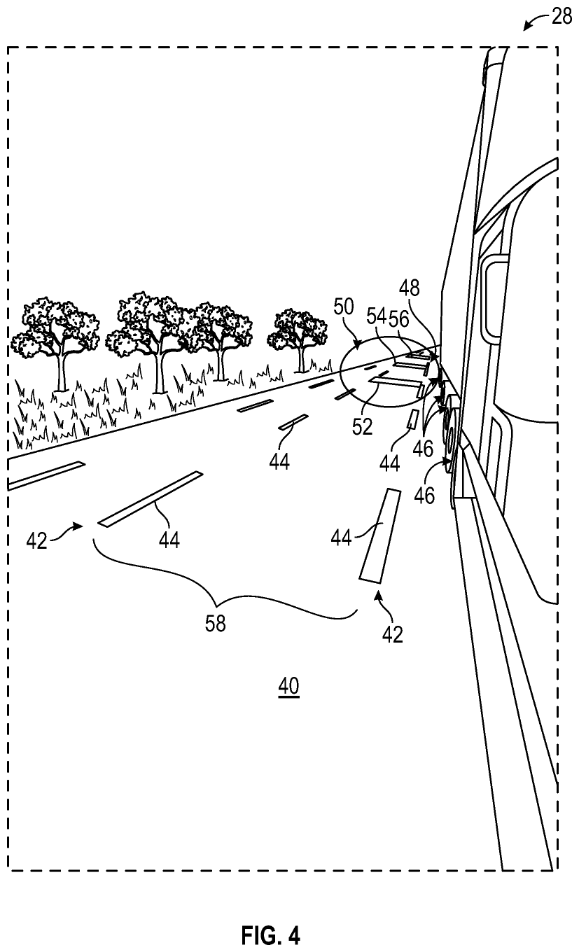

Referring to FIG. 4, the screen 28 of one of the displays 18a, 18b illustrates the vehicle and its trailer in a roadway 40. A typical roadway 40 includes adjacent lane markers 42 defining lanes of travel. In one example, the adjacent lane markers 42 comprise individual, discrete markings 44, such as painted dashes, which may communicate it is permissible to pass into the lane or communicate other information to drivers.

The line markers 42 can be identified using image processing of the images captured by the one or more cameras 20. One example technique for detecting lines or lane markers using a line recognition algorithm is disclosed in U.S. application Ser. No. 17/504,648, entitled “CAMERA MIRROR SYSTEM DISPLAY FOR COMMERCIAL VEHICLES INCLUDING SYSTEM FOR IDENTIFYING ROAD MARKINGS”, filed on Oct. 19, 2021 and incorporated herewith in its entirety.

Calculating an awareness line that is perpendicular to the adjacent lane marker (block 104) is performed with reference to the location of interest on the vehicle, for example, the trailer end. The trailer end is also used for determining awareness lines used to indicate a distance aft of the trailer end, e.g., a distance corresponding to an acceptable vehicle overtaking/passing distance. The location of interest is then used to determine the point on the lane marker at which the perpendicular awareness line is calculated. In cases in which the adjacent lane marker is curved, the awareness line is calculated perpendicular from a line tangent to the adjacent lane marker. The adjacent lane marker need not be the line immediately adjacent to the vehicle, but may be on the other side of the lane, based upon a curb, and/or a shoulder of the roadway.

For a location of interest such as the trailer end 48, various techniques may be used to identify the trailer end. The trailer end 48 can be determined at least in part by identifying the trailer's wheels 46, for example. One example technique of determining the trailer edge and displaying awareness lines is disclosed in provisional application Ser. No. 63/325,788, entitled “DYNAMIC LONGITUDINAL AND LATERAL ADJUSTMENT OF AWARENESS LINES FOR COMMERCIAL VEHICLE CAMERA MIRROR SYSTEM”, filed on Mar. 31, 2022 and incorporated herewith in its entirety. However, this disclosed technique displays the awareness lines horizontally on the display.

Once the perpendicular line from the location of interest has been determined, this perpendicular line is mapped from real world distance to pixel distance to determine how this imaginary line should be illustrated on the display 18 to the driver as a useful awareness line. In one example, it is desirable to display the awareness line as a line that corresponds to the width 58 of one adjacent lane in the roadway.

In the example, multiple awareness lines 50 are displayed. For example, a first awareness line 52 corresponds to the trailer end 48, a second awareness line 54 corresponds to a first distances aft of the trailer end 48, and a third awareness line 56 aft of the trailer end 48 and the second awareness line 54. Since the awareness lines 50 are displayed in such a way so as to correspond to the lane width 58, the awareness lines 50 become smaller in the direction of the vanishing point of the displayed image.

In terms of hardware architecture, such a computing device can include a processor, memory, and one or more input and/or output (I/O) device interface(s) that are communicatively coupled via a local interface. The local interface can include, for example but not limited to, one or more buses and/or other wired or wireless connections. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components.

The controller 30 may be a hardware device for executing software, particularly software stored in memory. The controller 30 can be a custom made or commercially available processor, a central processing unit (CPU), an auxiliary processor among several processors associated with the controller, a semiconductor-based microprocessor (in the form of a microchip or chip set) or generally any device for executing software instructions.

The memory can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory may incorporate electronic, magnetic, optical, and/or other types of storage media. The memory can also have a distributed architecture, where various components are situated remotely from one another, but can be accessed by the processor.

The software in the memory may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory.

The disclosed input and output devices that may be coupled to system I/O interface(s) may include input devices, for example but not limited to, a keyboard, mouse, scanner, microphone, camera, mobile device, proximity device, etc. Further, the output devices, for example but not limited to, a printer, display, etc. Finally, the input and output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

When the controller 30 is in operation, the processor can be configured to execute software stored within the memory, to communicate data to and from the memory, and to generally control operations of the computing device pursuant to the software. Software in memory, in whole or in part, is read by the processor, perhaps buffered within the processor, and then executed.

The disclosed method provides at least two benefits: (1) the awareness lines are confined to adjacent lane with the detection result of a lane maker and (2) the awareness lines are illustrated perpendicular to the lane marker. The displayed awareness lines help the driver to better estimate the distance of an object in the truck's blind spot near the trailer end, as they appear on the displays, to aid in making better judgement when maneuvering.

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples.

Although an example embodiment has been disclosed, a worker of ordinary skill in this art would recognize that certain modifications would come within the scope of the claims. For that reason, the following claims should be studied to determine their true scope and content.

What is claimed is:

1. A method of displaying awareness lines in a camera monitor system for a vehicle, comprising:
detecting an adjacent lane marker to the vehicle;
calculating an awareness line that is perpendicular to the adjacent lane marker; and
displaying the awareness line in relation to a trailer end location.

2. The method of claim 1, wherein the adjacent lane marker is at least one of a dashed line lane marker or a solid line lane marker in the roadway.

3. The method of claim 2, wherein the adjacent line is immediately adjacent to a tractor trailer indicative of the trailer end location.

4. The method of claim 1, comprising a step of capturing images with a camera, and wherein the detecting step is performed using a line recognition algorithm based upon the captured images.

5. The method of claim 4, comprising a step of mapping real world distance to pixel distance, and the displaying step includes displaying the pixel distance to illustrate the awareness line.

6. The method of claim 1, wherein the displaying step includes illustrating the awareness line at the trailer end location.

7. The method of claim 1, wherein the displaying step includes illustrating the awareness line aftward of the trailer end location to indicate a distance behind the trailer end location.

8. The method of claim 1, wherein the displaying step includes illustrating the awareness line as a width corresponding to one lane in the roadway.

9. The method of claim 1, wherein the adjacent lane marker is curved, and the awareness line is displayed perpendicular to a line tangent to the curved adjacent lane marker.

10. A camera monitor system for a vehicle comprising:
multiple cameras including first and second cameras respectively providing first and second fields of view;
multiple displays including first and second displays configured to respectively depict at least portions of the first and second fields of view;
a controller in communication with the first and second displays and the first and second cameras, the controller configured to detect an adjacent lane marker to the vehicle based upon images captured by at least one of the first and second camera, the controller configured to calculate an awareness line that is perpendicular to the adjacent lane marker and display the awareness line on at least one of the first and second displays in relation to a trailer end location of the vehicle.

11. The system of claim 10, wherein the first and second fields of view respectively capture left and right sides of a vehicle, each of the first and second fields of view include at least a portion of Class II and/or Class IV views.

12. The system of claim 10, wherein the adjacent lane marker is at least one of a dashed line lane marker or a solid line lane marker in the roadway.

13. The system of claim 12, wherein the adjacent line is immediately adjacent to a tractor trailer indicative of the trailer end location.

14. The system of claim 10, wherein the controller is configured to perform a line recognition algorithm to identify the adjacent lane marker based upon the captured images.

15. The system of claim 14, wherein the controller is configured to map real world distance to pixel distance, and the awareness line illustrates the pixel distance.

16. The system of claim 10, wherein the controller is configured to illustrate the awareness line on the at least one of the first and second displays at the trailer end location.

17. The system of claim 10, wherein the controller is configured to illustrate the awareness line aftward of the trailer end location to indicate a distance behind the trailer end location.

18. The system of claim 10, wherein the controller is configured to illustrate the awareness line as a width corresponding to one lane in the roadway.

19. The system of claim 10, wherein the adjacent lane marker is curved, and the controller is configured to display the awareness line perpendicular to a line tangent to the curved adjacent lane marker.
